(19) United States
(12) Patent Application Publication
(10) Pub. No.: US 2015/0056581 A1
(43) Pub. Date: Feb. 26, 2015

(54) SYSTEM AND METHOD FOR LEARNING MATHEMATICS

(71) Applicant: SLTG Pte Ltd., Singapore (SG)

(72) Inventor: Meng Kian TAI, Singapore (SG)

(21) Appl. No.: 14/506,601

(22) Filed: Oct. 3, 2014

Related U.S. Application Data
(63) Continuation of application No. PCT/SG12/00486, filed on Dec. 21, 2012.
Application No. PCT/SG12/00486 is a continuation-in-part of application No. PCT/SG12/00121, filed on Apr. 5, 2012.

(51) Int. Cl. G09B 7/04; G09B 23/02

(52) U.S. Cl. CPC G09B 7/04; G09B 23/02
USPC 434/188

(57) ABSTRACT

The present invention provides a system for teaching mathematics comprising: a student input module configured to select an exercise from a group consisting of homework, a race or competition, and practice; a teacher input module configured to select an exercise parameter from a group consisting of setting a home work exercise from scratch, revising a home work exercise based on student results or comparing results between different groups; a question selection module to randomly generate a question depending on the exercise selected and/or the parameter; an answer module configured to parse a response to the question, and to display a result, a dynamically generated graphic and/or any applicable explanation depending on the response; and an avatar module configured to vocalise the explanation depending on a predetermined set of rules for vocalising certain mathematical explanations.

### FIELD

The present invention relates to a system and method for learning mathematics.

### BACKGROUND

Traditional methods for learning mathematics are based on direct instruction (using textbooks focusing on standard arithmetic methods) where students are taught one standard method of performing a task, in a standard sequence. The task is however taught in isolation rather than as only a part of a more complex project, which may then result in the students being unable to fully grasp and master the necessary conceptual understanding.

In addition, there is a time gap between when the students have completed the homework exercises and when an instructor (i.e. teacher) is able to provide explanations for incorrectly answered questions in the exercises (which understandably can only be done after the teacher has finished marking). By then, the students may already have lost impression of the practise.

Moreover, mastery of important mathematical solving techniques typically requires repetitive practise over a period of time, which may eventually bore the students. Fading interest or lack of motivation may also result from using the route-based learning approach, or lack of variation should they wish to do more practising.

### SUMMARY

In general terms the invention relates to a website which teaches mathematical skills to students by generating random questions for each skill, and uses an avatar to describe the solution. The website allows the teacher to monitor student's progress and to vary the homework accordingly. This may have the advantage that the students do not get bored learning each skill, that mastering skills may be made more enjoyable and/or that the speed of progress is improved. A question answer module may have the technical benefit of saving the teacher or parent time and may result in more effective learning by the student, and an analysis module may have the technical benefit of improved accuracy of the measured outcome. An avatar module may have the technical benefit of improving the efficacy of the students learning.

According to a first aspect, there is provided a system for teaching mathematics comprising:
a student input module configured to select an exercise form the group consisting of homework, a race or competition, and practice;
a teacher input module configured to select an exercise parameter from the group consisting of setting a home work exercise from scratch, revising a home work exercise based on student results or comparing results between different groups;
a question selection module to randomly generate a question depending on the exercise selected and/or the parameter;
an answer module configured to parse a response to the question, and to display a result, a dynamically generated graphic and/or any applicable explanation depending on the response; and
an avatar module configured to vocalise the explanation depending on a predetermined set of rules for vocalising certain mathematical explanations.

The race exercise may comprise a set of questions to be answered by a group of students, and the winner may be a student who answers all the questions correctly the soonest after the race starts.

The revising a home work exercise based on student results may comprise selecting the types of questions the students scored the lowest at, and generating a new homework exercise focusing on those types of questions.

The question selection module may generate a question based on a question framework, each framework being unique to the type of question requested, the framework including variables to be randomly selected for each question iteration.

The answer module may generate an answer based on an answer framework, each framework being unique to the type of question requested, the framework including an answer for the immediately preceding question.

The predetermined set of rules may comprise the student selected avatar display parameters, speed, grammar and parsing of mathematical expressions/units.

The result may include a textual answer statement, the dynamically generated graphic included graphic attributes for input to a Flash module and an explanation script flash graphics generation.

The system may further comprise a tweak module to allow a teacher or a student to request another similar question to the preceding question before moving onto the next skill level.

It should be apparent that features relating to one aspect of the invention may also be applicable to the other aspects of the invention.

These and other aspects of the invention will be apparent from and elucidated with reference to the embodiments described hereinafter.

### BRIEF DESCRIPTION OF THE DRAWINGS

One or more embodiments will be disclosed with reference to the accompanying drawings, in which:

FIG. 1a is a screenshot of a student's home webpage;

FIG. 1b is a screenshot of a teacher's home webpage;

FIG. 2a is a flow diagram illustrating a method of learning mathematics;

FIG. 2b is a block diagram of the software modules;

FIG. 3 shows an exemplary categorisation of questions stored in a database.

FIG. 4a shows the generation of parallel questions within a skill;

FIG. 4b shows the output data structure for a pair of questions and solution generated set within a skill;

FIG. 5 shows two pairs of parallel question and solution set generated within in a skill (data samples);

FIG. 6 shows an assessment analysis page where analytical homework creator may be used;

FIGS. 7 to 9 show screen shots of a custom practice routine;

FIGS. 10 to 13 show screen shots of a quick pick routine;

FIG. 14 show screen shots of a create scheduled homework routine;

FIG. 15 show screen shots of a peer quiz routine;

FIGS. 16 to 18 show screen shots of a teach tweak routine; and

FIGS. 19 to 23 show screen shots of an accuracy bar and tabulated results.

### DETAILED DESCRIPTION

A website for learning mathematics will now be described according to an example embodiment. The website uses sophisticated logic to generate a large number of permutations of questions and automatically generates easily understandable answers and explanations. Users of this website may be students, teachers or parents. The answers and explanations are provided in text, shown graphically and gradually explained by an avatar. The website allows a separate login facility for students and teachers.

### Web Server

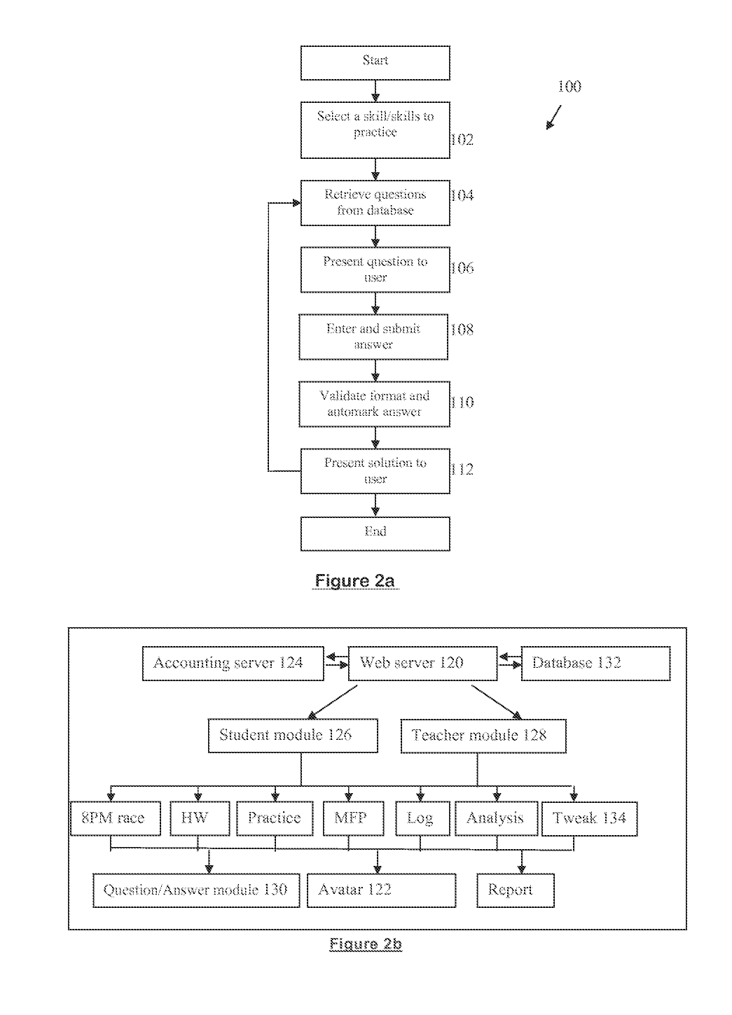

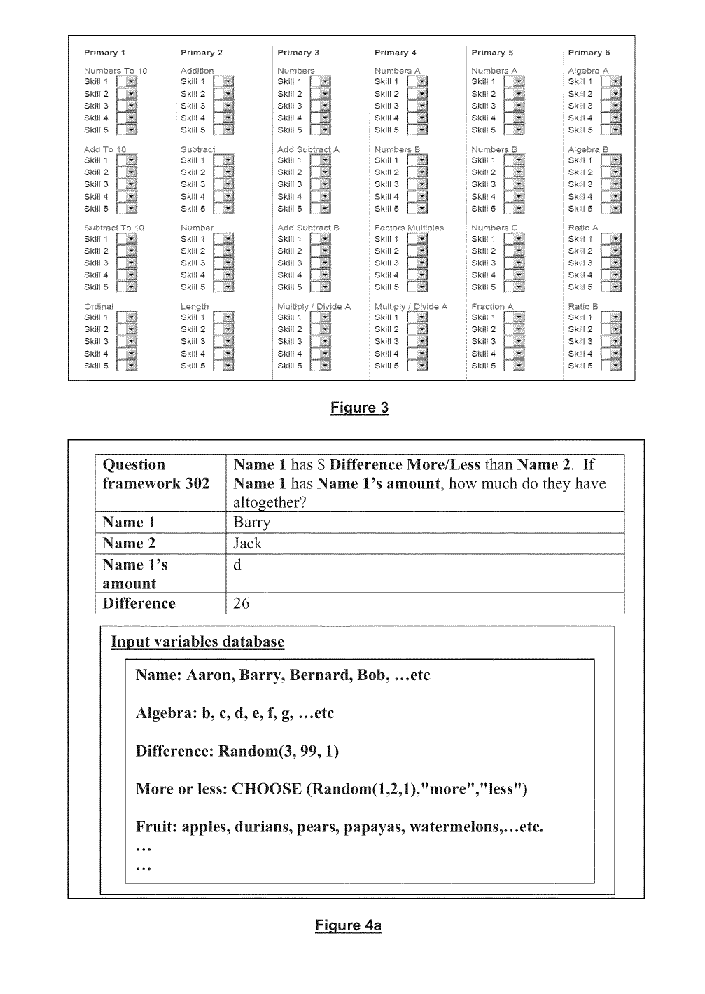

The website is hosted on a web server 120 as shown in FIG. 2b. It is running a range of software modules and interfaces with other servers, including an avatar 122 and an accounting server 124. The accounting sever 124 may limit availability of different features, or access to data depending on the time of the day and/or account level of the user who logs in. The web server 120 may include a MySQL database. The scripting language may be Hypertext Preprocessor (PHP).

Any of the modules, systems and/or methods disclosed below may alternatively be implemented on a private network, or as a standalone application.

### Student Module 126

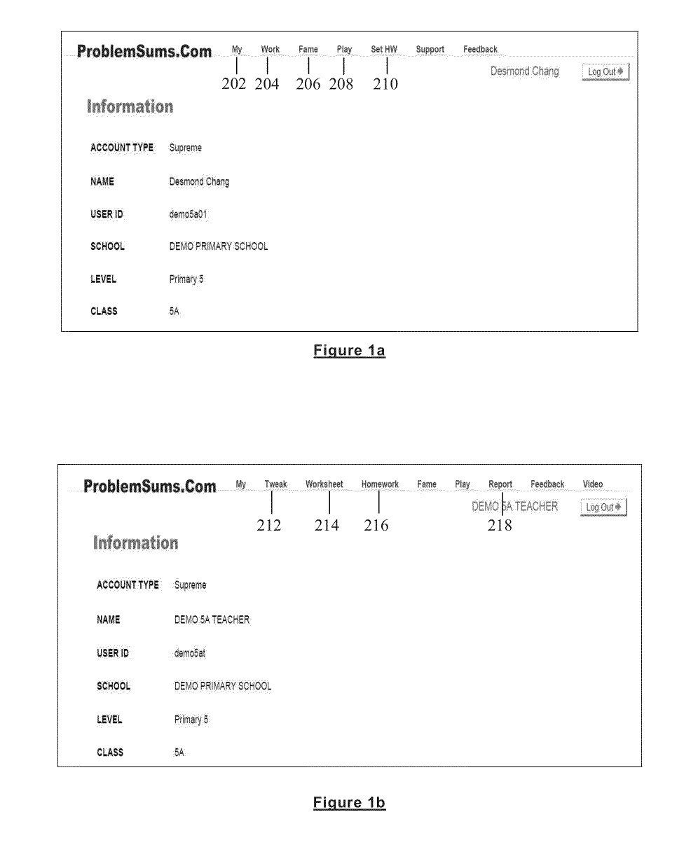

FIG. 1a is a screenshot of a student's home page. Under the “My” tab 202 the student may edit personal information, select a wall paper, customise the avatar, monitor any achievements and keep a log of past exercises done.

Under the “Work” tab 204 the student has a choice of a 8 pm race, a practice/test or homework. For each option different questions are raised depending on the age/school level of the student. Submitted answers will be automatically marked by the website and a full set of solution is available for each question so that the students are able to get immediate feedback after attempting the questions. Explanation is provided in detail in both graphical as well as vocal form, by the avatar.

Under the “Fame” tab 206 the student can see the results for the Bpm race, interclass competition, the overall results compared to students at the same school level, and the monthly results for students at the same school level.

Under the “Play” tab 208 there is a game called Math Facts Power (MFP). This keeps a weekly high score of whoever is the best at answering as many questions as possible in each of four categories for a time period. The categories are addition, subtraction, multiplication and division and the time period is one minute each.

There are also a range of other mathematics related games that the student can use to refresh mental stamina levels when getting bored.

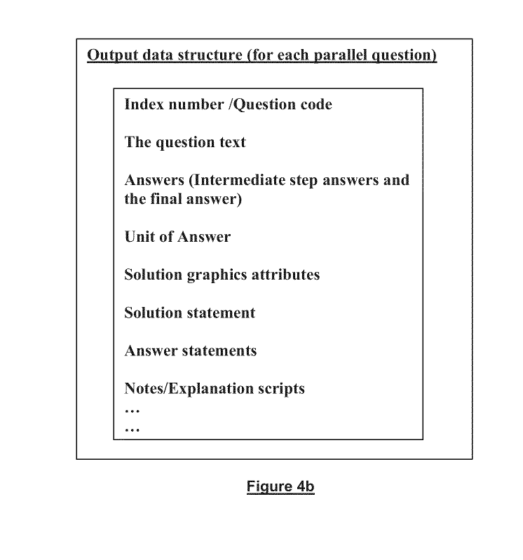

Under the “Set HW” tab 210 the student or parent can set a homework exercise using selection criteria as shown in FIG. 3. This will be described in more detail under the heading of “Homework automation” and “Analytical homework creator”. As such, parents will be able to supervise and monitor their child's learning with ease by setting homework for their child. Student's correct attempts will contribute to their scores and the record may be tracked and maintained for a period of time to monitor their progress. Students with high scores may be displayed in “hall of fame” under a “Fame” tab 206 to stimulate their interest in learning and reinforce regular practice. Races (under “Work” tab 204) may also be conducted on a regular basis via the online system to allow participants to have interactions and virtual competition with each other.

### Teacher Module

FIG. 1b shows a screenshot of a teacher's home page. Under the “Tweak” tab 212, the teacher is able to get as many examples of each skill as he or she wants for classroom teaching. With the help of this function, the teacher may easily choose more questions from a particular skill for students to focus on.

The teacher may choose to refer to the text and answer solution in describing this to the students, or may utilise the avatar and graphical explanation by displaying the webpage to the class.

The “Worksheet” tab 214 is similar to the “Set HW” tab 210 for students (shown in FIG. 3), in that it can be used to generate a set of questions for use during class. Various parameters can be set to determine how much working room, formatting options and ordering.

Under the “Homework” tab 216, the teacher can set and monitor homework. Similar to the generation of a worksheet, the homework can be set using the selection criteria shown in FIG. 3. The results are shown in a table format showing the solution and how many students got each right. Homework groups can also be set, to select particular students for different homework allocations.

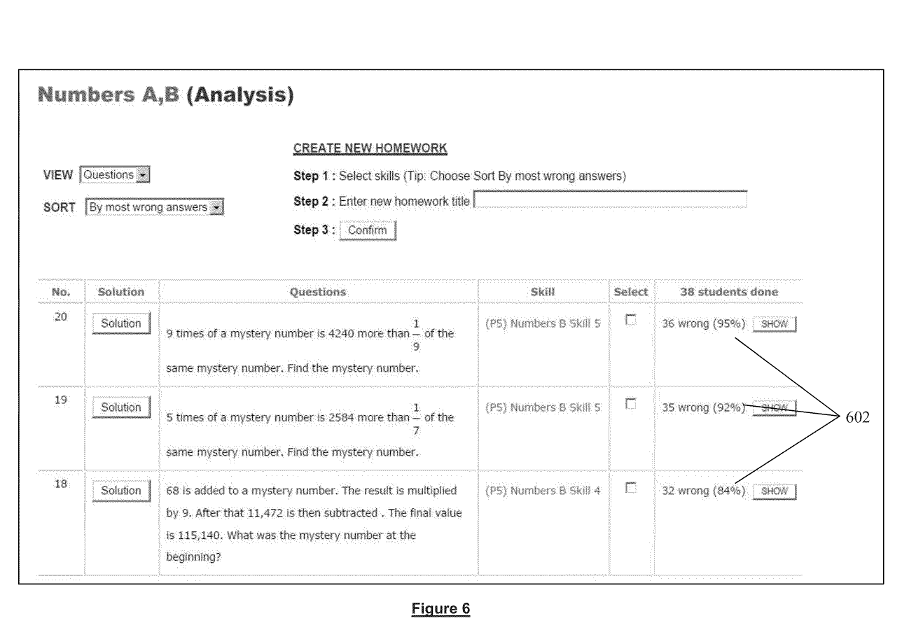

Under the “Report” tab 218, the school can generate reports at different levels, such as by teacher, by class, by level etc. Assessment results may be analysed automatically to provide information of students' performance. For example, the system provides homework analysis by question in real-time with percentage of wrong answers among those who completed the homework. An example is shown in FIG. 6.

### Question & Answer Module

For example when a student selects the practice/test option under the “Work” tab 204, they are presented with a range of skills and levels to be answered. Each is represented by a star. When the student hovers over a star a box appears with an example of the type of question.

When the student clicks on a star the question answer module operates according to the method 100 as shown in FIG. 2a. A student may select a skill/skills to practice in step 102. The number of questions that the student wishes to practice for each skill may be also indicated at this step. In response, the web server 120 will retrieve a question at the selected skill in step 104.

The questions are presented to the student in step 106 via a webpage. Additionally the student may request an online avatar 122 to also read out the questions.

In step 108, the student enters an answer (either by entering text, number, radio buttons or clicking on icons and submitting the answer to the system. The data entry is then validated for format using automaker in step 110. The student entered answers are then matched against stored answers to determine whether the answers are correct or incorrect in step 110.

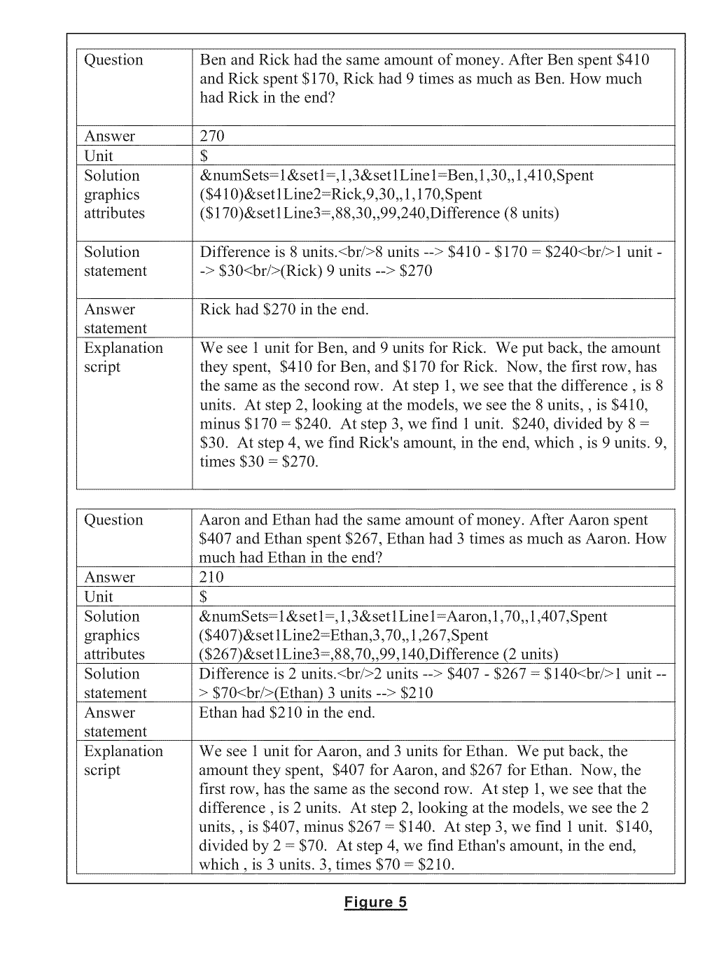

After attempting one question, the student has the choice to retry a similar question, move on to the next skill or access a detailed solution. The detailed solution may include a text solution statement, an answer statement, unit of answer, solution graphic attributes and explanation script, as shown in FIG. 4b. The solution statement consists of step-by-step detail workings towards the solution to the question. Solution graphics attributes contain information such as the file location of a picture or programming attributes for a flash graphic or a picture to be generated. Solution graphic attributes may contain variables that may be determined by the flash object whether the drawing is a table or sets of models. For tables, the variables provide information for the table layout, heading and cell contents. For the set of models, the variables provide information for the number of sets of models, layout, heading, and models content including wordings, colour and length of model. The explanation script is designed for vocalisation by a character animation or avatar 122, if the student clicks on listen.

Upon completion of the current question, the user has an option to use/attempt another question of the same skill based on a previously presented or attempted question via functions such as tweak 134, homework automation and analytical homework creator. In particular, when the system is used in “student module” 126, a student may use the “tweak” function 134 to practice another question of the same skill as the previously attempted question. Similarly, parents may use “homework automation” to automatically generate a new set of homework comprising questions of the same skill as that of previously wrongly answered questions. Based on the result analysis of completed homework, teachers may create new homework directly on the analysis page by choosing questions from the skill for which the most students answered wrongly.

### Avatar

The system is also provided with an online avatar 122 which is capable of reading questions and solutions to give the student a real human-teaching experience. There is an external engine that performs Text-to-Speech function which allows the avatar 122 to speak any text dynamically, in real time with accurate lip-synching through real human voices. The appearance of the avatar 122 may be customized in terms of facial features (for example, hair color/style, eye color, mouth, nose, etc), body features (clothing, body size, etc) and even voice and tone of speech.

The avatar 122, a flash object, is loaded on pages where voice performances are applicable. Each LISTEN/EXPLAIN button is linked to a javascript command to generate the text for the avatar 122. When a user clicks on button LISTEN/EXPLAIN, the pre-stored question/explanation script is sent to the text-to-speech engine to return a voice file to the user's browser. The pre-stored script consists of text to be spoken, volume, users stored avatar preferences and speed commands to control the pace and grammar of the speech. For some mathematic expressions it is necessary to pre-parse this script, for example, to convert fractions or units etc into a compatible text string for vocalisation.

### Question Generation

The questions may be dynamically generated using a logic framework, or every permutation may be stored in a database 132 and randomly selected. In either case, the logic will use a certain question and answer format for each skill type at each level.

In the worksheet shown in FIG. 3 there are 6 levels (Primary 1 to Primary 6) of questions and each level comprises four chapters with each chapter including five skills. The skills (Skill 1-5) progress in terms of difficulty levels over each chapter.

In order to generate the respective questions for each skill a question framework 302 may be provided as shown in FIG. 4a. This may generate parallel questions that are variations of the same type of question. The variation results because variables such as names, objects, quantities, etc are part of the template logic and are randomly selected every time the question is iterated.

Thus the question framework 302 can either be iterated in real-time every time a question is requested or a large database can store the result of a large number of such iterations. In either case a different framework is used for each level, chapter and skill level to which the question belongs. For example, a question code P6raa155 corresponds to the 55^{th} parallel question in the level Primary 6 chapter Ratio A skill 1.

To facilitate students' self-learning ability, user entered answers are marked automatically and detailed solution set is also automatically generated using a similar framework to the question framework. The answer framework also includes logic for automatically generating scripts for graphic generation, and text string to be validated to parsing to the avatar 122. Similarly the answer framework can either be iterated in real-time every time an answer is provided or a large database can store the result of a large number of such iterations.

For example, if 99 pairs of parallel questions and solution are generated by a Macro for a skill P6raa1 (Primary 6 Ratio A skill 1), each pair will then be assigned a non-overlapping question code from P6raa101-P6raa199, respectively. The above described frameworks may be implemented with software such as Microsoft Excel or visual basic or may be integrated into the webserver software. An example of the parallel questions and solutions is as shown in FIG. 5.

### Homework Automation

Teachers, parents or students can select a set of skills to practice using the selection criteria shown in FIG. 3. Based on this, the website randomly generates the selected number of questions. For example, parents and teacher may set homework for the students, and teachers may also conduct test and print worksheets based on generated questions.

When parents set homework using the homework automation function, for any questions that were wrongly answered, the website may regenerate another similar question until the student gets it right. A parallel question from the same skill to that of each of the wrongly answered questions is randomly selected and presented for the student to solve. This process may be repeated until the student manages to correctly answer the questions that were answered wrongly in previous assessment. This function helps the student identify their weak points and actively reinforce their skills in those aspects by practicing the questions of the same kind.

### Analytical Homework Creator

As mentioned above the teacher is able to analyse students' test/homework assessment results statistically in terms of percentages of wrongly answered students for each individual questions in text, as well as graphically, using graphs or charts.

Based on the analysis derived from existing homework, the teacher may set new homework by focussing on the skills which students find difficulty. As shown in FIG. 6, the assessment results 602 show that 95% of the students answered wrongly for P5 Number B Skill 5 and 84% of the students answered wrongly for P5 Number B Skill 4. Then the teacher can select those skills to generate parallel questions to create new homework. As described above, the web server 120 is then configured to randomly select questions from those skills and present the questions to the student.

### 8 pm Race

Online races maybe conducted on a regular basis for each level of students. Each race may comprise a pre-defined number of questions randomly selected from the database 132, and the selected questions are made available to the participants at a stipulated time. In a preferred embodiment, each race is catered for a group of participants of the same level (one race for each of Primary 1 to Primary 6). The web server 120 is configured to present a list of pre-stored questions of the same level for each race. The web server 120 analyses and ranks the results of accuracy and time of submission. The winner is the one who answers the most questions correctly the soonest after the race starts.

### Custom Practice

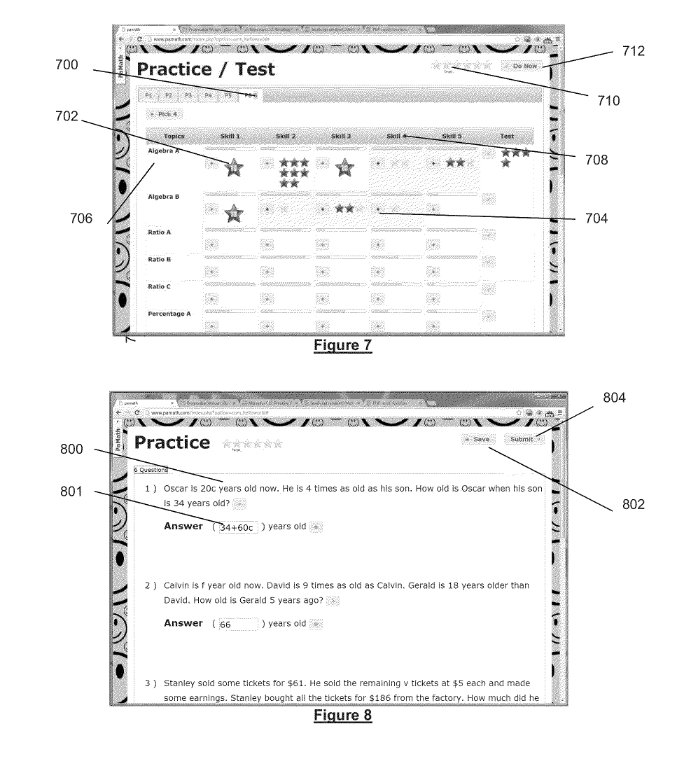

According to an alternative embodiment, a method of customising a practice question session is shown in FIGS. 7 to 9. For example when a student selects the practice/test option under the “Work” tab 204, they are presented with a range of skills and levels to be answered. In FIG. 7 the student has clicked P6 700, representing their current year of study. Again the stars 702 show the number of questions under the skill/level that have already been correctly answered.

For each new practice, the system obtains new questions. The student may manually click the “+” button 704 to add question from particular skill (eg, 2 questions from Algebra A 706 Skill 4 708, etc) for that practise. Once the desired number of questions has been selected, the student selects a number of stars 710 to represent a target number of correct answers for this practise. The student then clicks “Do now” 712 to start practice.

The actual questions may be dynamically generated using a logic framework, or every permutation may be stored in the database 132, as described previously. For each skill a random question text is selected to generate the question.

FIG. 8 shows the generated questions 800, and the student entering answers 801. The student has the option to save 802 the practice for later or to submit 804 for marking now. The users answers may be stored in real-time on web server 120, or may be temporarily stored locally if connectivity to the web server 120 is not online.

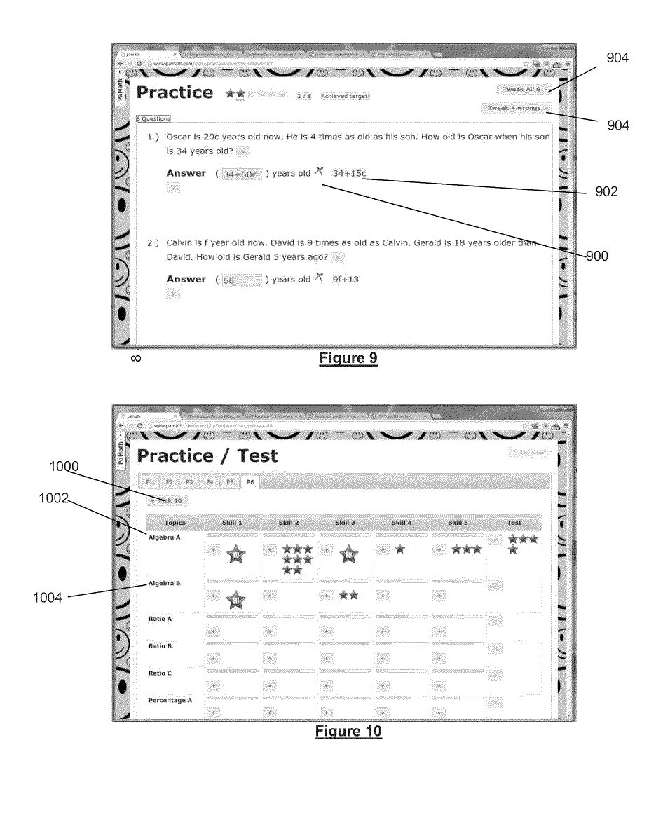

FIG. 9 shows the marks 900 for each question after submitting 804 for marking, and the corrected answer 902 for the wrong answers. The student has option to do another practice on similar set of skills 904 or to do another practice on questions that he got wrong 906.

### Quick Pick System

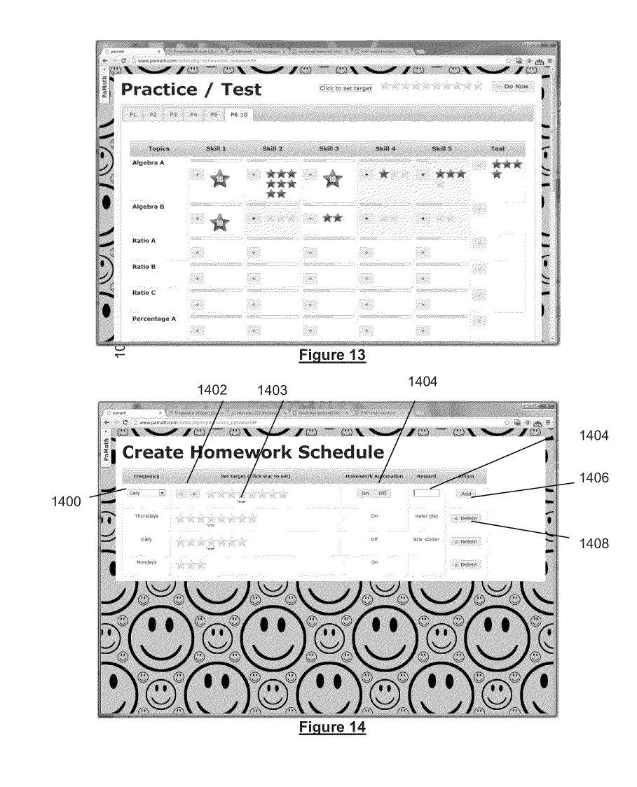

According to another alternative embodiment, instead of manually selecting skills, FIG. 10 shows a “Quick Pick” option 1000 which uses a weighted selection algorithm to automatically pick 10 questions from the database 132 for the current level of student, (eg: Primary 6 skills for Primary 6 student). Initially the user may manually select skills they want to include, as shown in FIG. 12, and then “quick pick” the remaining questions to make up 10 as shown in FIG. 13.

The web server 120 picks questions based on the progress through the school year, and the number of correctly answered questions in each category. For example in the month of January, only questions from the first 10 skills are eligible eg: Algebra A 1002 and Algebra B 1004. In February the first 20 skills, so Ratio A and Ratio B are added. This is intended to roughly follow the lessons on the same topics during the school year. If there are 90 skills, then by September the full set of skills are eligible. The web server 120 starts from the beginning to scan for skills with no earned (previously correctly answered) stars or selected star/skill within the given skill zone. Each selection of a skill results in one question for that skill.

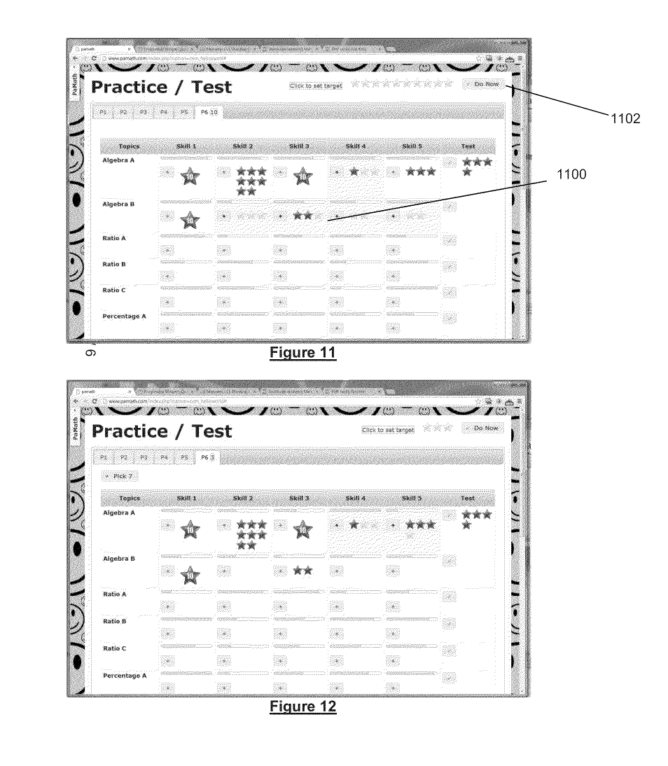

If after a first round of scanning the skill zone, not all 10 questions are allocated, the web server 120 proceeds to scan for skills with 1 earned/selected star within the skill zone, and so on for 2, 3 etc stars until all required selections are made. Each automatic selection counts as a selected star. As shown in FIG. 11 the process was partially through the 3rd star iteration 1100 when 10 stars had been selected. The student can then select “do now” 1102 to generate the questions.

If after scanning for 9 earned/selected stars within the skill zone not all questions are allocated, the same process extends outside of the skill zone. If the entire 90 questions have been exhausted then it will select questions from the next level of student eg: P5->P6. If the maximum level is already reached, the process begins again as if there are no stars in the current level.

### Scheduled Homework

According to a further alternative embodiment, the student can set scheduled homework as shown in FIG. 14. The selections include frequency 1400 (Daily, Mondays, Tuesdays, Wednesdays, Thursdays, Fridays, Saturdays or Sundays), + and − buttons 1402 for the number of questions, a target 1403 number of correct answers, whether the homework automation feature(system auto generates another homework from the wrongly answered question of the scheduled homework done) 1404 is enabled and whether there is a reward 1406. Once the attributes are selected the student clicks “add” 1406 to save that schedule. Existing scheduled homework can be removed by selecting “delete” 1408 beside that line.

### Peers Quiz System

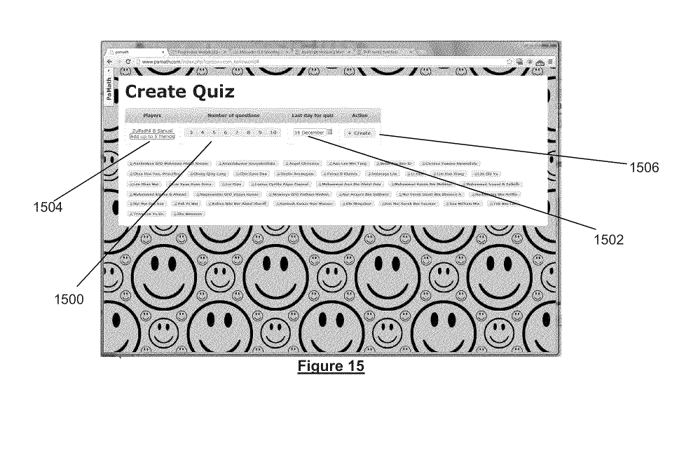

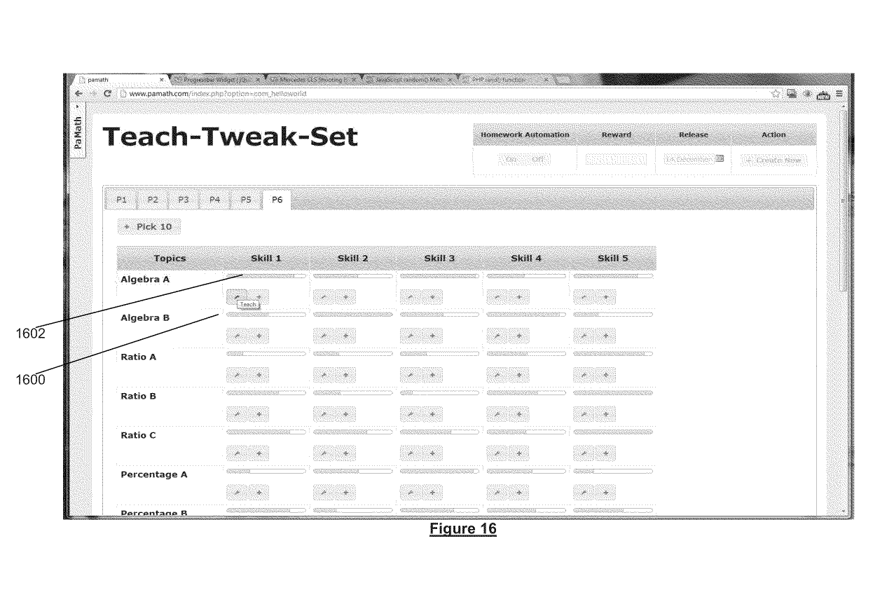

According to a still further alternative embodiment, the student can create a quiz as shown in FIG. 15. The student selects the number of questions 1500, closing date for the quiz 1502, and friends 1504 to include (class mates or students with the same star status). Once the student clicks on “create” 1506 the same generated quiz questions will appear in each contestant's menu. The quiz will be instantaneously marked (like practices) but the result will only be shown either after the deadline or after all contestants have completed the quiz, whichever is earlier. The quiz ranking is then determined based on most correct answers followed by shortest time taken to complete the quiz. The rankings are displayed to each contestant.

### Teach-Tweak-Set Panel

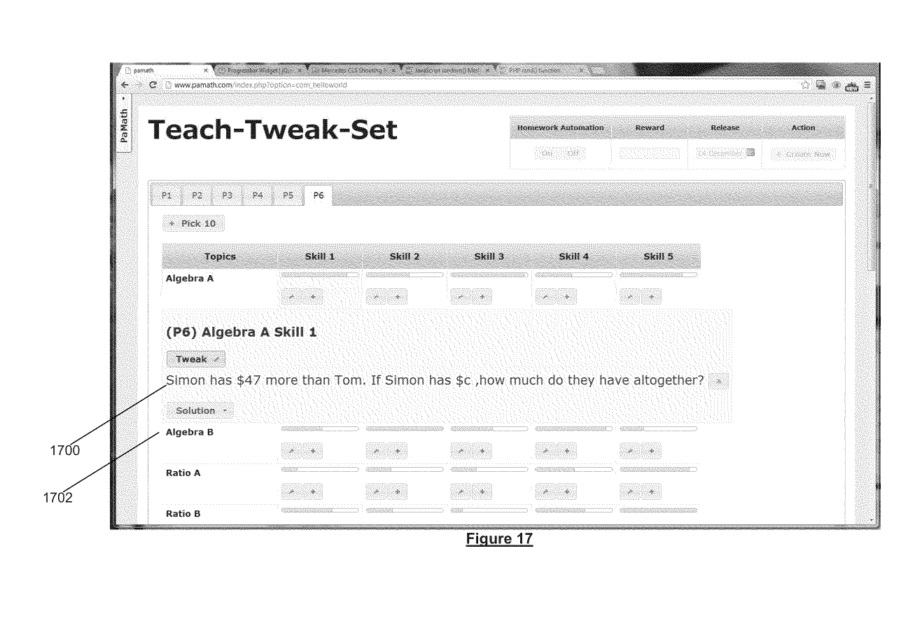

As shown in FIG. 16 the Teacher clicks Teach button 1600 under a given skill 1602, and as shown in FIG. 17 a sample question 1700 for that skill is shown. The Teacher can click on the solution button 1702 to display an accompanying solution for teacher to teach. If necessary, the Teacher can click the Tweak button 1800 show in FIG. 18, the generate a similar question 1802 for the same skill, to reinforce teaching.

The Teacher can also clicks on Set 1804 to add questions to be set as homework for the students. Similarly the quick pick button 1806 is also available to set homework for the students.

### Accuracy Bar

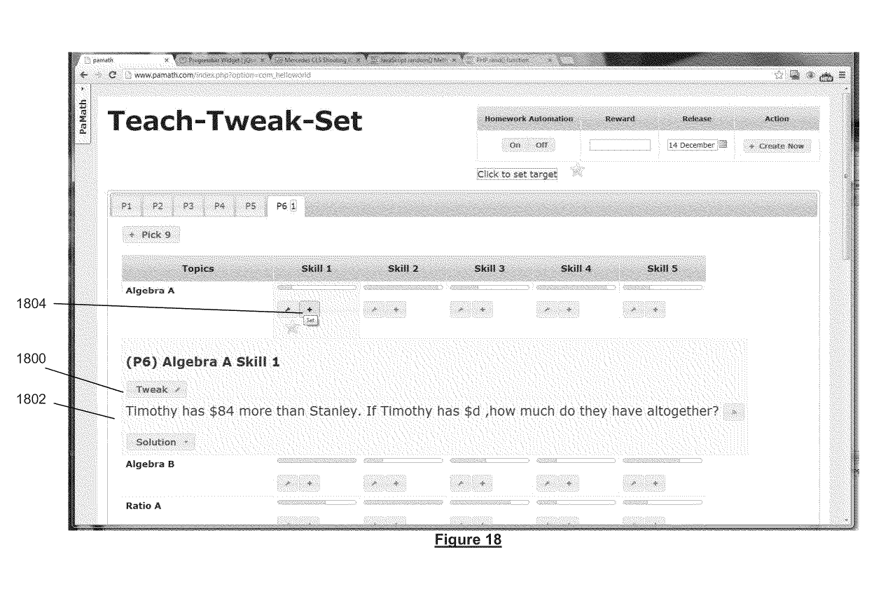

In a further embodiment FIG. 19 shows in Students' Practice/Set Homework pages the bar 1900 above each box of stars indicates the accuracy of that students attempts on the skills (from all activities including practices, tests, quizzes, homework and race). A fuller bar indicates good performances (fully shaded bar means 100% accuracy).

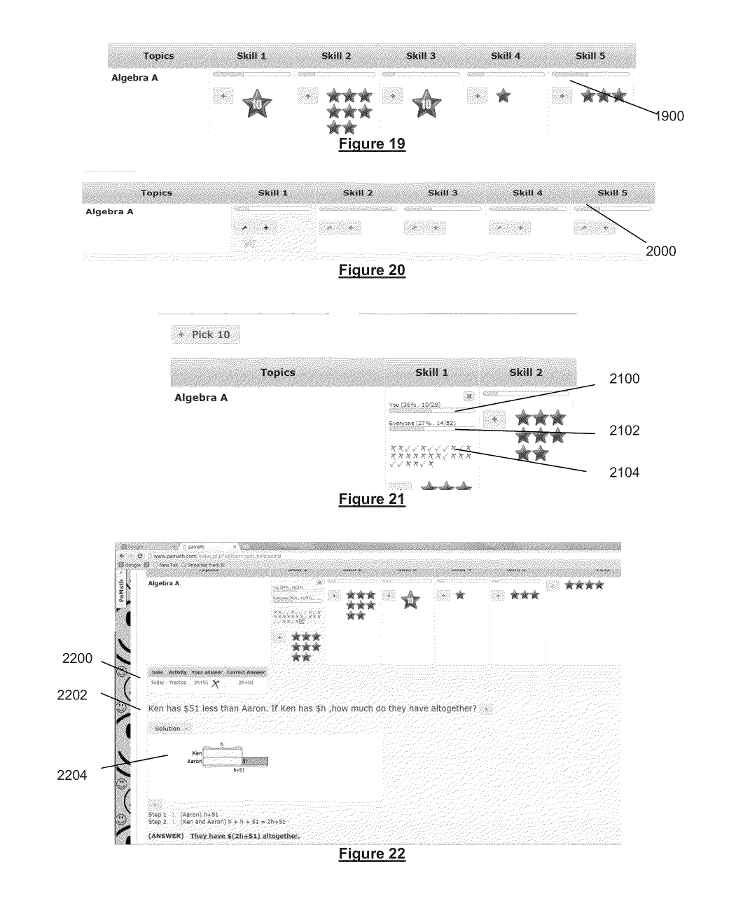

In FIG. 20, in the Teacher screen, the bar 2000 shows the accuracy of all of the students attempts at the skill.

In FIG. 21 when a student clicks on the accuracy bar, more details are shown:
(1) User accuracy information (You, 36%, 10/28) 2100
(2) Everyone accuracy information (Everyone, 27%, 14/52) 2102
(3) (For students only) History of users' 28 attempts in graphic forms of ticks and crosses 2104

When the student clicks on one of the ticks or crosses 2104, as shown in FIG. 22, that particular attempt will be displayed with
(1) Attempt information (Date, Activity Type, User answer, Correct answer) 2200
(2) Question 2202
(3) Solution 2204

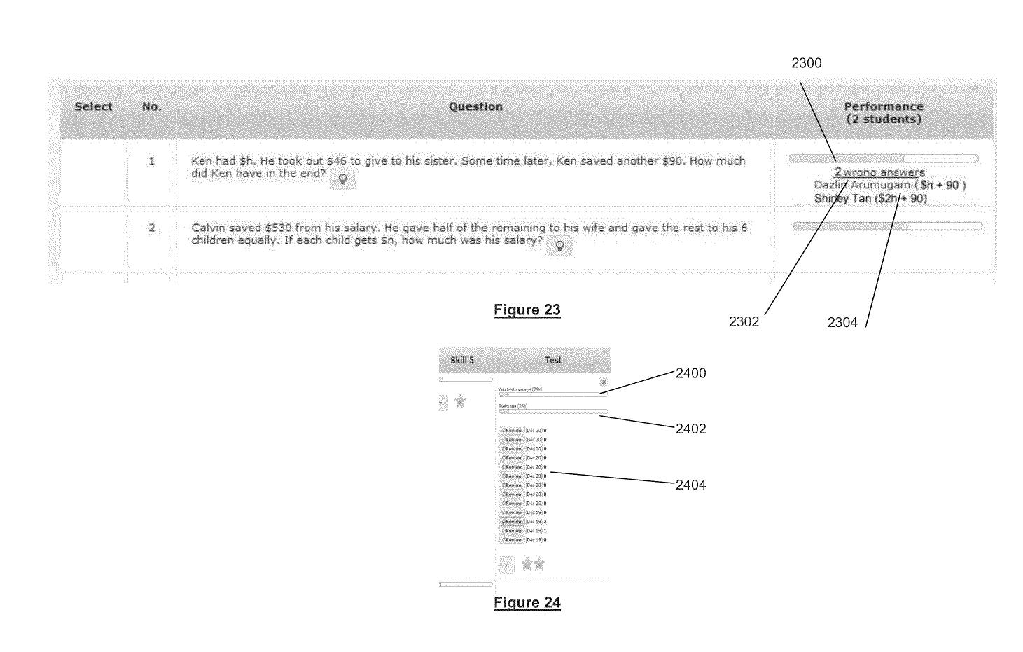

FIG. 23 shows an alternative Teachers' Homework List Panel, where a fuller bar 2300 indicates good performances (fully shaded bar means all attempts were correct). When the bar is clicked, detailed information will be shown:
(1) Number of wrong answers 2302
(2) Name of student and their wrong answers 2304

FIG. 24 shows the results screen for Students in relation to a test. When the student click's on the accuracy bar 2400 for tests, more details are shown:
(1) User test average (Your test average,2%) 2402
(2) Everyone (Everyone, 2%) 2404
(3) History of users' 13 test attempts 2406

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

1. A system for teaching mathematics comprising:
a student input module configured to select an exercise from a group consisting of homework, a race or competition, and practice;
a teacher input module configured to select an exercise parameter from a group consisting of setting a home work exercise from scratch, revising a home work exercise based on student results or comparing results between different groups;
a question selection module to randomly generate a question depending on the exercise selected and/or the parameter;
an answer module configured to parse a response to the question, and to display a result, a dynamically generated graphic and/or any applicable explanation depending on the response; and
an avatar module configured to vocalise the explanation depending on a predetermined set of rules for vocalising certain mathematical explanations.

2. The system in claim 1 wherein the race exercise comprises a set of questions to be answered by a group of students, and the winner is the student who answers all the questions correctly the soonest after the race starts.

3. The system in claim 1, wherein the revising a home work exercise based on student results homework automation comprises selecting the types of questions the students scored the lowest at, and generating a new homework exercise focusing on those types of questions.

4. The system in claim 1, wherein the predetermined set of rules comprises, the student selected avatar display parameters, speed, grammar and parsing of mathematical expressions/units.

5. The system in claim 1, wherein the question selection module generates a question based on a question framework, each framework being unique to the type of question requested, the framework including variables to be randomly selected for each question iteration.

6. The system in claim 5 wherein the answer module generates an answer based on an answer framework, each framework being unique to the type of question requested, the framework including an answer for the immediately preceding question.

7. The system in claim 1, wherein the result includes a textual answer statement, the dynamically generated graphic included graphic attributes for input to a Flash module and an explanation script flash graphics generation.

8. The system in claim 1, further comprising a tweak module to allow a teacher or a student to request another similar question to the preceding question before moving onto the next skill level.

9. The system in claim 1, further comprising a custom practice module to select skills for practice, wherein the question selection module parameters include the selected skills.

10. The system in claim 1, further comprising a quick pick module to automatically select skills for practice based on the date, selected skills and/or the number of previously correct answers for each skill, wherein the question selection module parameters include the selected skills.

11. The system in claim 1, further comprising a scheduled homework module for selecting the frequency of homework, the number of questions, the target accuracy rate, whether to automate the response to incorrect answers and/or for whether a reward is provided, wherein the question selection module parameters include the number of skills.

12. The system in claim 1, further comprising a peer quiz module to select the number questions for a quiz, the quiz deadline and the contestants, wherein the question selection module parameters include the number of questions.

13. The system in claim 1, further comprising a teach tweak set module to generate a question for a skill selected by a teacher, to generate another question for the selected skill and/or to add the selected skill to a homework exercise for the students, wherein the question selection module parameters include the selected skills.

14. The system in claim 1, further comprising an accuracy bar module to automatically display a bar graph and/or tabulated data relating to the accuracy of the results from the answer module.
